(19) United States
(12) Patent Application Publication
(10) Pub. No.: US 2014/0136861 A1
(43) Pub. Date: May 15, 2014

(54) DATA REQUEST PATTERN GENERATING DEVICE AND ELECTRONIC DEVICE HAVING THE SAME

(71) Applicant: Samsung Electronics Co., Ltd., Suwon-Si (KR)

(72) Inventors: Soo-Yong KIM, Hwaseong-si (KR); Jun-Ho HUH, Yongin-si (KR); Kee-Moon CHUN, Seongnam-si (KR)

(73) Assignee: Samsung Electronics Co., Ltd., Suwon-Si (KR)

(21) Appl. No.: 14/071,801

(22) Filed: Nov. 5, 2013

(30) Foreign Application Priority Data
Nov. 12, 2012 (KR) 10-2012-0127108

(51) Int. Cl. G06F 1/26; G06N 5/04

(52) U.S. Cl. CPC G06F 1/26; G06N 5/047
USPC 713/300; 710/30

(57) ABSTRACT

A data request pattern generating device may include a sequence detector configured to generate data request sequence information based on a plurality of data request signals. The data request signals may be output from a plurality of function blocks. The device may include a time detector configured to generate data request time information based on the data request signals. The device may include a pattern generator configured to generate a data request pattern based on the data request sequence information and the data request time information.

### CROSS-REFERENCE TO RELATED APPLICATION(S)

This application claims priority under 35 USC §119 to Korean Patent Applications No. 10-2012-0127108, filed on Nov. 12, 2012 in the Korean Intellectual Property Office (KIPO), the contents of which are incorporated herein in its entirety by reference.

### BACKGROUND

1. Technical Field

Some example embodiments relate generally to a power-gating technique. More particularly, example embodiments of the inventive concepts relate to a data request pattern generating device for performing a power-gating operation, and an electronic device having the data request pattern generating device.

2. Description of the Related Art

Recently, an electronic device (e.g., mobile device) may be manufactured in a small size. Nevertheless, the electronic device includes a central processing unit (e.g., processor) and a plurality of modules that perform various functions (e.g., a communication function, a camera function, etc.). These modules are often referred to as intellectual properties (IP). Generally, each intellectual property corresponds to circuits, logical devices, or combinations thereof, where the circuits or the logical devices can be integrated in a system on-chip (SOC). In addition, an operation of the intellectual property may be controlled by the central processing unit.

Meanwhile, as the electronic device is required to perform more functions based on limited power (i.e., battery) for portability, it becomes an important factor for evaluating performance of the electronic device whether the electronic device can operate at low power. Thus, to reduce power consumption, the electronic device selectively supplies power to the intellectual properties based on internal operating modes (e.g., normal mode, idle mode, etc.) thereof.

When the electronic device selectively supplies power to the intellectual properties based on internal operating modes of the intellectual properties (i.e., referred to as a power-gating operation), the electronic device needs to detect an operating state of respective intellectual properties in real-time, and to promptly control a power supplying operation based on the operating state of respective intellectual properties. However, since a specific delay is caused when conventional electronic devices control the power supplying operation based on the operating state of respective intellectual properties, the conventional electronic devices cannot efficiently perform the power-gating operation.

### SUMMARY

Some example embodiments provide a data request pattern generating device capable of generating a data request pattern due to user's use habits in a reinforcement learning manner without any involvement of a central processing unit (e.g., processor).

Some example embodiments provide an electronic device having the data request pattern generating device capable of efficiently perform a power-gating operation based on a data request pattern due to user's use habits (i.e., an operating pattern of intellectual properties due to the user's use habit).

According to an example embodiment, a data request pattern generating device is provided. The device may include a sequence detector configured to generate data request sequence information based on a plurality of data request signals. The data request signals may be output from a plurality of function blocks. The device may include a time detector configured to generate data request time information based on the data request signals. The device may include a pattern generator configured to generate a data request pattern based on the data request sequence information and the data request time information.

In example embodiments, the data request pattern generating device may further include a memory device configured to store the data request pattern.

In example embodiments, the function blocks may correspond to a plurality of modules.

In example embodiments, the function blocks may correspond to a plurality of internal blocks included in at least one module.

In example embodiments, the pattern generator is configured to generate pattern comparison information by determining whether a first data request pattern is consistent with a at least one second data request pattern. The first data request pattern may correspond to the data request signals that are currently input. The at least one second data request pattern may be stored in the memory device.

In example embodiments, the first data request pattern may include data request sequence information that indicates a first data request sequence. The second data request pattern may include second data request sequence information that indicates a second data request sequence. The data request pattern generating device is configured to determine that the first data request sequence information is consistent with second data request sequence information when the first data request sequence is compared with the second data request sequence multiple times in succession, and based on the comparisons, the first data request sequence substantially matches the second data request sequence more than a desired number of times.

In example embodiments, the first data request pattern may include first data request time information indicating a first data request time and the second data request pattern may include second data request time information indicating a second data request time. The data request pattern generating device is configured to determine that the first data request time information is consistent with second data request time information when a difference between the first data request time and the second data request time is maintained to be equal to or less than a desired threshold value.

In example embodiments, the device may further include a power management integrated circuit (PMIC) configured to use the second data request pattern for performing a power-gating operation when the first data request pattern is consistent with the second data request pattern.

In example embodiments, the pattern generator configured to store the first data request pattern in the memory device when the first data request pattern is inconsistent with the second data request pattern.

According to an example embodiment, an electronic device is provided. The electronic device may include first through (n)th function blocks configured to output first through (n)th data request signals, where n is an integer equal to or greater than 1. Each of the first through (n)th function blocks may have an internal operation mode, and the request signals may be based on the internal operating mode of each of the first through (n)th function blocks. The electronic device may include a power management integrated circuit configured to supply power to the first through (n)th function blocks, and perform a power-gating operation for the first through (n)th function blocks based on the internal operating modes. The electronic device may include a data request pattern generating device configured to generate a data request pattern based on the first through (n)th data request signals, and provide the data request pattern to the power management integrated circuit for the power-gating operation.

In example embodiments, the data request pattern generating device may include a sequence detector configured to generate data request sequence information based on the first through (n)th data request signals, a time detector configured to generate data request time information based on the first through (n)th data request signals, a pattern generator configured to generate the data request pattern based on the data request sequence information and the data request time information, and a memory device configured to store the data request pattern.

In example embodiments, the device may further include a plurality of intellectual properties, each of the plurality of intellectual properties including a plurality of internal blocks. The first through (n)th function blocks may correspond to a plurality of intellectual properties, or a plurality of internal blocks included in each of the intellectual properties.

In example embodiments, the data request pattern generating device is configured to generate a first data request pattern corresponding to a currently input data request pattern. The first data request pattern may be based on a data request pattern of the first through (n)th data request signals. The device is configured to generate pattern comparison information by determining whether the first data request pattern is consistent with at least one second data request pattern. The second data request pattern may be stored in the memory device. The determination is based on multiple comparisons of the first data request pattern and the second data request pattern, and based on the comparisons, the first data request pattern is consistent with the second data request pattern if the first data request pattern substantially matches the second data request pattern more than a desired number of times

In example embodiments, the data request pattern generating device configured to use the second data request pattern to perform the power-gating operation when the first data request pattern is consistent with the second data request pattern.

In example embodiments, the data request pattern generating device configured to store the first data request pattern in the memory device when the first data request pattern is inconsistent with the second data request pattern.

According to an example embodiment, a data request pattern generating device is provided. The device configured to learn an operating pattern without involvement of a central processing unit, and perform a power-gating operation without involvement of a central processing unit, the power-gating operation being performed according to the learned operating pattern.

In example embodiments, the operating pattern may be based on a use pattern of a plurality of function blocks.

In example embodiments, the device may be further configured to generate a data request pattern based on the use pattern. The data request pattern may include data request sequence information and data request time information.

In example embodiments, the device may be further configured to generate pattern comparison information by determining whether a first data request pattern is consistent with at least one second data request pattern. The first data request pattern may be based on a currently input data request pattern, and the second data request pattern may be stored in a memory device. The second data request pattern may be based on a previously input data request pattern.

In example embodiments, the device may be further configured to determine whether the first data request pattern is consistent with the second data request pattern, store the first data request pattern in the memory device if the first data request pattern is determined not to be consistent with the second data request pattern, and use the second data request pattern for performing the power-gating operation if the first data request pattern is determined to be consistent with the second data request pattern.

Therefore, a data request pattern generating device according to example embodiments may generate a data request pattern having data request sequence information and data request time information based on data request signals in a reinforcement learning manner without any involvement of a central processing unit (e.g., processor) when modules generate the data request signals based on user's use habits. As a result, an operating pattern of modules due to the user's use habit may be accurately estimated.

In addition, an electronic device having the data request pattern generating device according to example embodiments may efficiently perform a power-gating operation based on a data request pattern due to user's use habits (i.e., an operating pattern of modules due to the user's use habit). As a result, a power-gating operation for each module of the electronic device may be accurately and rapidly performed.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a data request pattern generating device according to an example embodiment.

FIG. 2 is a flow chart illustrating an example in which a data request pattern generating device of FIG. 1 generates a data request pattern.

FIG. 3 is a timing diagram illustrating an example in which a data request pattern generating device of FIG. 1 generates a data request pattern.

FIG. 4 is a diagram illustrating an example of a data request pattern that is generated by a data request pattern generating device of FIG. 1.

FIG. 5 is a flow chart illustrating an example in which a data request pattern generating device of FIG. 1 compares a data request pattern that is currently input with a data request pattern that is stored in a memory device.

FIG. 6 is a diagram illustrating an example in which a data request pattern generating device of FIG. 1 compares a data request pattern that is currently input with a data request pattern that is stored in a memory device.

FIG. 7 is a flow chart illustrating an example in which a data request pattern generating device of FIG. 1 determines whether a data request pattern that is currently input is consistent with a data request pattern that is stored in a memory device.

FIG. 8 is a diagram illustrating an example in which a data request pattern generating device of FIG. 1 determines whether a data request pattern that is currently input is consistent with a data request pattern that is stored in a memory device.

FIG. 9 is a flow chart illustrating an example in which a data request pattern generating device of FIG. 1 stores new data request pattern in a memory device.

FIGS. 10A and 10B are diagrams illustrating an example in which a data request pattern generating device of FIG. 1 stores new data request pattern in a memory device.

FIG. 11 is a block diagram illustrating a data request pattern generating device according to an example embodiment.

FIG. 12 is a block diagram illustrating an electronic device according to an example embodiment.

FIG. 13 is a flow chart illustrating an example in which an electronic device of FIG. 12 performs a power-gating operation based on a data request pattern.

FIG. 14 is a timing diagram illustrating an example in which an electronic device of FIG. 12 performs a power-gating operation based on a data request pattern.

FIG. 15 is a diagram illustrating an example in which an electronic device of FIG. 12 is implemented as a smart-phone.

### DETAILED DESCRIPTION OF THE EMBODIMENTS

Various example embodiments will be described more fully hereinafter with reference to the accompanying drawings, in which some example embodiments are shown. The present inventive concepts may, however, be embodied in many different forms and should not be construed as limited to the example embodiments set forth herein. Rather, these example embodiments are provided so that this disclosure will be thorough and complete, and will fully convey the scope of the present inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

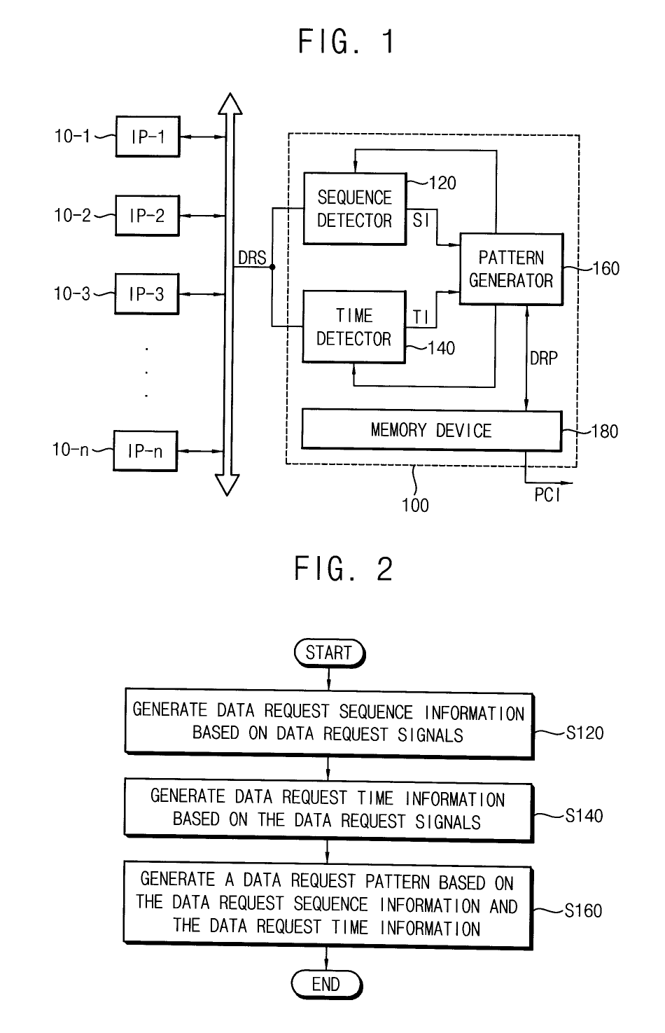

FIG. 1 is a block diagram illustrating a data request pattern generating device according to example embodiments.

Referring to FIG. 1, the data request pattern generating device 100 may include a sequence detector 120, a time detector 140, a pattern generator 160, and a memory device 180. Although it is illustrated in FIG. 1 that the memory device 180 is placed within the data request pattern generating device 100 (i.e., internal memory device), the memory device 180 may be placed outside the data request pattern generating device 100 (i.e., external memory device).

The sequence detector 120 may generate data request sequence information SI based on data request signals DRS output from a plurality of function blocks 10-1 through 10-n. Specifically, the sequence detector 120 may detect the data request signals DRS output from the function blocks 10-1 through 10-n by monitoring the function blocks 10-1 through 10-n, and may generate the data request sequence information SI corresponding to a sequence in which the function blocks 10-1 through 10-n output respective data request signals DRS. In one example embodiment, the data request signal DRS may correspond to a signal for requesting a use of bus (e.g., referred to as a bus request signal). Subsequently, the sequence detector 120 may output the data request sequence information SI to the pattern generator 160. In one example embodiment, as illustrated in FIG. 1, the function blocks 10-1 through 10-n may correspond to at least one intellectual property (IP). In this case, the sequence detector 120 may generate the data request sequence information SI related to the intellectual property. In another example embodiment, the function blocks 10-1 through 10-n may correspond to a plurality of internal blocks of the intellectual property. In this case, the sequence detector 120 may generate the data request sequence information SI related to the internal blocks of the intellectual property.

Generally, one or more of the intellectual properties may correspond to components of an electronic device. For example, the intellectual properties may include a central processing unit (CPU), at least one core of the central processing unit, a graphic processing unit (GPU), a multi-format codec (MFC), a video module (e.g., camera interface, joint photographic experts group (JPEG) processor, video processor, etc.), an audio system, a display driver, a memory device, a memory controller, a serial port, a system timer, and/or other like components. Here, since one or more of the intellectual properties (or, internal blocks of the intellectual properties) require different power consumption parameters according to characteristics thereof, the intellectual properties may receive power from a power management integrated circuit (PMIC) based on internal operating modes (e.g., normal mode, idle mode, and the like) thereof (not shown). In addition, the PMIC may perform a power-gating operation for the intellectual properties (or, internal blocks of the intellectual properties). Hereinafter, it is assumed in FIG. 1 that the function blocks 10-1 through 10-n correspond to the intellectual properties.

The time detector 140 may generate data request time information TI based on the data request signals DRS output from the function blocks 10-1 through 10-n. Specifically, the time detector 140 may detect the data request signals DRS output from the function blocks 10-1 through 10-n by monitoring the function blocks 10-1 through 10-n, and may generate the data request time information TI corresponding to a time at which the function blocks 10-1 through 10-n output respective data request signals DRS. In one example embodiment, the data request time information TI may include a duration time of respective data request signals DRS output from the function blocks 10-1 through 10-n, a delay time between respective data request signals DRS output from the function blocks 10-1 through 10-n, etc. Subsequently, the time detector 140 may output the data request time information TI to the pattern generator 160.

The pattern generator 160 may receive the data request sequence information SI from the sequence detector 120, may receive the data request time information TI from the time detector 140, and may generate a data request pattern DRP based on the data request sequence information SI and the data request time information TI. Specifically, the pattern generator 160 may generate the data request pattern DRP having a sequence shape by merging the data request sequence information SI and the data request time information TI. Generally, the data request pattern DRP may have only expectable diversity because a user's use habit exists when the user uses the electronic device. For example, the user may repeatedly use specific programs (e.g., specific application programs) when the user uses a smart-phone, or other like computing device. In this case, the data request pattern DRP generated by the pattern generator 160 may have a specific shape (i.e., similar shape). Thus, a power-gating operation for the function blocks 10-1 through 10-n may be efficiently performed based on the data request pattern DRP repeatedly generated by the pattern generator 160 when a shape of the data request pattern DRP that is currently input is similar to a shape of the data request pattern DRP repeatedly generated by the pattern generator 160.

The memory device 180 may store the data request pattern DRP generated by the pattern generator 160. Here, since the memory device 180 does not store all data request patterns DRP due to a limited capacity, the data request pattern DRP generated by the pattern generator 160 (hereinafter, referred to as a first data request pattern) may be compared with the data request pattern DRP stored in the memory device 180 (hereinafter, referred to as a second data request pattern). Based on the comparison result, the memory device 180 may store the first data request pattern generated by the pattern generator 160, or may update the second data request pattern stored in the memory device 180. Specifically, when the first data request pattern generated by the pattern generator 160 is similar to the second data request pattern stored in the memory device 180, the second data request pattern stored in the memory device 180 may be updated based on the first data request pattern generated by the pattern generator 160. On the other hand, when the first data request pattern generated by the pattern generator 160 is not similar to the second data request pattern stored in the memory device 180, the first data request pattern generated by the pattern generator 160 may be stored in the memory device 180. In example embodiments, when the memory device 180 does not have a spare space, the second data request pattern stored in the memory device 180 may be deleted based on a predetermined or otherwise desired order of priority (e.g., according to how a number of times the second data request pattern was generated, according to an age of the second data request pattern, and the like), and then the first data request pattern generated by the pattern generator 160 may be stored in the memory device 180.

Specifically, the data request pattern generating device 100 may generate pattern comparison information PCI by determining whether the first data request pattern generated by the pattern generator 160 is consistent with at least one second data request pattern stored in the memory device 180, where the first data request pattern generated by the pattern generator 160 corresponds to a generating pattern of the data request signals DRS that are currently input (i.e., an operating pattern of the intellectual properties due to the user's use habit). Thus, the data request pattern generating device 100 may be configured to output the pattern comparison information PCI, which indicates that the first data request pattern generated by the pattern generator 160 is consistent with the second data request pattern stored in the memory device 180 when a generating pattern of the data request signals DRS that are currently input (i.e., the first data request pattern generated by the pattern generator 160) is consistent with the second data request pattern stored in the memory device 180. As a result, a power-gating operation for the function blocks 10-1 through 10-n may be performed by expecting a generating pattern of the data request signals DRS based on the second data request pattern stored in the memory device 180. On the other hand, the data request pattern generating device 100 may output the pattern comparison information PCI, which indicates that the first data request pattern generated by the pattern generator 160 is not consistent with the second data request pattern stored in the memory device 180 when a generating pattern of the data request signals DRS that are currently input (i.e., the first data request pattern generated by the pattern generator 160) is not consistent with the second data request pattern stored in the memory device 180. In this case, the data request pattern generating device 100 may store the first data request pattern generated by the pattern generator 160 in the memory device 180.

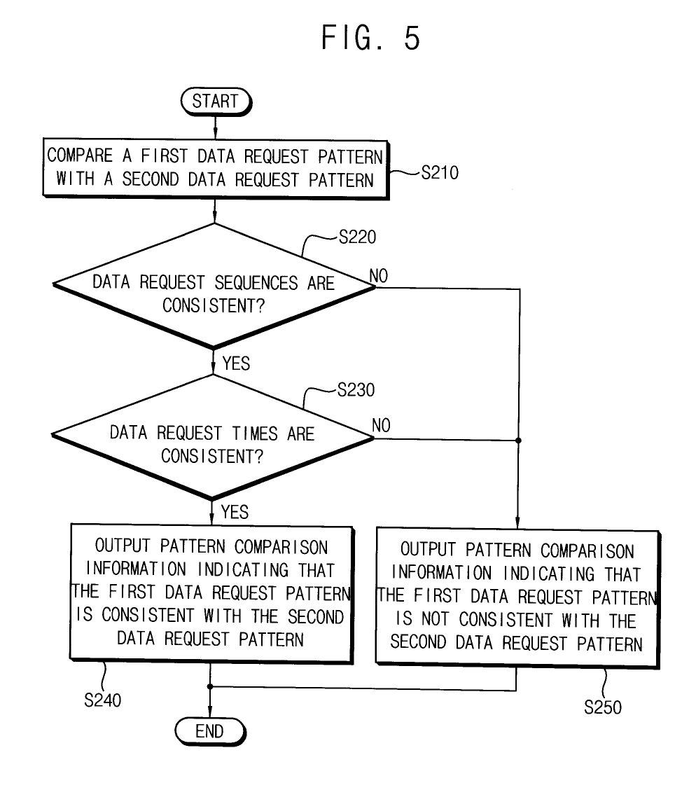

In one example embodiment, the data request pattern generating device 100 determines whether the first data request pattern generated by the pattern generator 160 is consistent with the second data request pattern stored in the memory device 180 as described below. The data request pattern generating device 100 may determine that first data request sequence information of the first data request pattern generated by the pattern generator 160 is consistent with second data request sequence information of the second data request pattern stored in the memory device 180 when a data request sequence of the first data request pattern generated by the pattern generator 160 is consistent with or substantially matches a data request sequence of the second data request pattern stored in the memory device 180 by more than a predetermined and/or desired number of times in succession. In addition, the data request pattern generating device 100 may determine that first data request time information of the first data request pattern generated by the pattern generator 160 is consistent with second data request time information of the second data request pattern stored in the memory device 180 when a difference between a data request time of the first data request pattern generated by the pattern generator 160 and a data request time of the second data request pattern stored in the memory device 180 is maintained to be equal to or less than a predetermined or otherwise desired threshold value. Subsequently, the data request pattern generating device 100 may determine that the first data request pattern generated by the pattern generator 160 is consistent with the second data request pattern stored in the memory device 180 when the first data request sequence information is consistent with the second data request sequence information and the first data request time information is consistent with the second data request time information. These operations will be described with reference to FIGS. 5 through 8.

As described above, the data request pattern generating device 100 uses characteristics that a specific pattern of bus traffic due to the user's use habit exists. Thus, the data request pattern generating device 100 may accurately estimate an operating pattern of the function blocks 10-1 through 10-n due to the user's use habit by generating the data request pattern DRP including the data request sequence information SI and the data request time information TI based on the data request signals DRS in a reinforcement learning manner without any involvement of the central processing unit when the function blocks 10-1 through 10-n generate the data request signals DRS according to the user's use habit. In addition, since the data request pattern generating device 100 makes an electronic device expect a generating pattern of the data request signals DRS based on the data request pattern DRP stored in the memory device 180, the electronic device having the data request pattern generating device 100 may increase or otherwise maximize power savings by performing a power-gating operation for the function blocks 10-1 through 10-n without any involvement of the central processing unit. Meanwhile, since the data request pattern generating device 100 generates an accurate data request pattern DRP by continuously comparing the first data request pattern generated by the pattern generator 160 with the second data request pattern stored in the memory device 180 (i.e., in the reinforcement learning manner), the data request pattern generating device 100 may reduce a probability that a generating pattern of the data request signals DRS is erroneously expected.

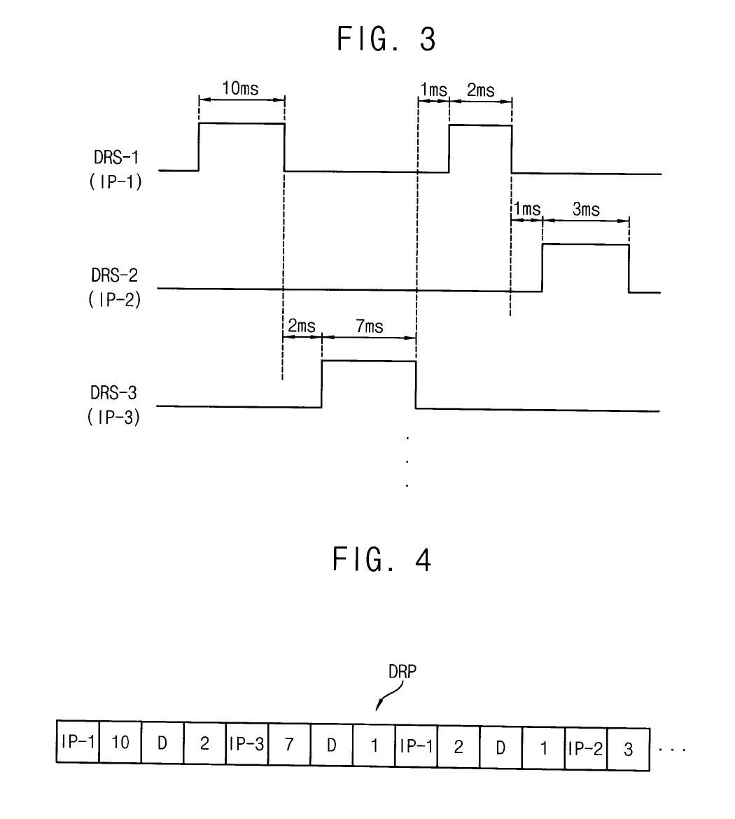

FIG. 2 is a flow chart illustrating an example in which a data request pattern generating device of FIG. 1 generates a data request pattern. FIG. 3 is a timing diagram illustrating an example in which a data request pattern generating device of FIG. 1 generates a data request pattern. FIG. 4 is a diagram illustrating an example of a data request pattern that is generated by a data request pattern generating device of FIG. 1.

Referring to FIG. 2, as shown in operation S120, the data request pattern generating device 100 generates the data request sequence information based on the data request signals DRS-1 through DRS-3 output the from function blocks IP-1 through IP-3. In various embodiments, the data request pattern generating device 100 may use the sequence detector 120 to generate the data request sequence information.

As shown in operation S140, the data request pattern generating device 100 generates the data request time information based on the data request signals DRS-1 through DRS-3 output from the function blocks IP-1 through IP-3. In various embodiments, the data request pattern generating device 100 may use the time detector 140 to generate the data request time information.

As shown in operation S160, the data request pattern generating device 100 generates a data request pattern DRP based on the data request sequence information and the data request time information. In various embodiments, the data request pattern generating device 100 may merge the data request sequence information and the data request time information to generate the data request pattern DRP by using the pattern generator 160.

FIG. 3 shows that the data request signals DRS-1 through DRS-3 are output from the function blocks IP-1 through IP-3. FIG. 4 shows that the data request pattern DRP is generated based on the data request signals DRS-1 through DRS-3. It should be noted that the present inventive concepts are not limited to the example embodiments as shown in FIGS. 3-4. As illustrated in FIG. 3, the first function block IP-1 may output the first data request signal DRS-1 during a duration time of 10 millisecond (ms), and then the third function block IP-3 may output the third data request signal DRS-3 during a duration time of 7 ms when a delay time of 2 ms elapses. Subsequently, the first function block IP-1 may output the first data request signal DRS-1 during a duration time of 2 ms when a delay time of 1 ms elapses, and then the second function block IP-2 may output the second data request signal DRS-2 during a duration time of 3 ms when a delay time of 1 ms elapses. Thus, the data request pattern generating device 100 may generate the data request sequence information indicating that the data request signals are generated in the order named (i.e., the first function block IP-1 -> the third function block IP-3 -> the first function block IP-1 -> the second function block IP-2) (operation S120). In addition, the data request pattern generating device 100 may generate the data request time information indicating that the data request signals are generated in the order named (i.e., the duration time of 10 ms -> the delay time of 2 ms -> the duration time of 7 ms -> the delay time of 1 ms -> the duration time of 2 ms -> the delay time of 1 ms -> the duration time of 3 ms) (operation S140). Thus, the data request pattern generating device 100 may generate the data request pattern DRP having a sequence shape (e.g., indicated as {IP-1, 10, D(delay), 2, IP-3, 7, D(delay), 1, IP-1, 2, D(delay), 1, IP-2, 3, . . . }) by merging the data request sequence information and the data request time information (operation S160). Here, the data request pattern generating device 100 may store the data request pattern DRP having a sequence shape in the memory device 180. As a result, an electronic device may use (i.e., refer to) the data request pattern DRP having a sequence shape when performing a power-gating operation. Since a shape of the data request pattern DRP illustrated in FIG. 4 is an example, a shape of the data request pattern DRP may be designed in various ways according to required conditions.

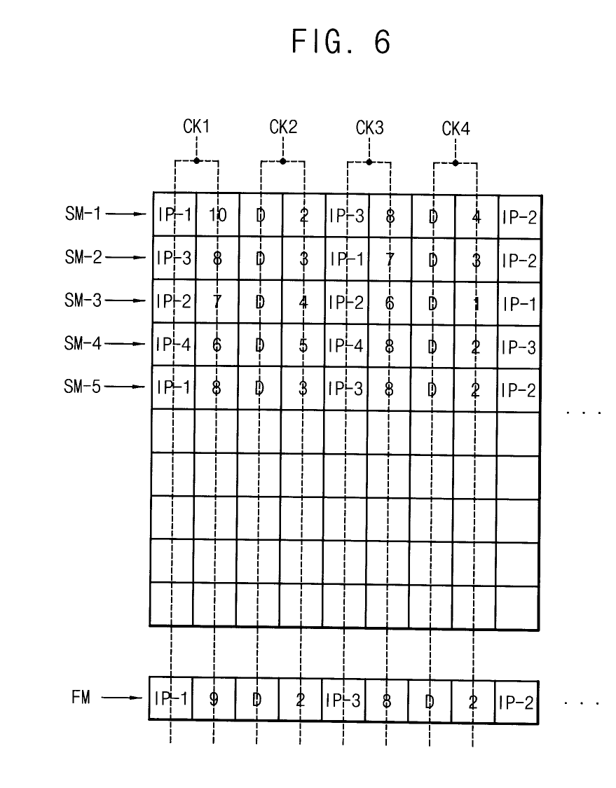

FIG. 5 is a flow chart illustrating an example in which a data request pattern generating device of FIG. 1 compares a data request pattern that is currently input with a data request pattern that is stored in a memory device. FIG. 6 is a diagram illustrating an example in which a data request pattern generating device of FIG. 1 compares a data request pattern that is currently input with a data request pattern that is stored in a memory device.

Referring to FIGS. 5 and 6, as shown in operation S210, the data request pattern generating device 100 may compare a first data request pattern FM generated by the pattern generator 160 with a second data request pattern SM stored in the memory device 180. As shown in operation S220, the data request pattern generating device 100 determines whether a data request sequence of the first data request pattern FM is consistent with or substantially matches a data request sequence of the second data request pattern SM by more than a predetermined or otherwise desired number of times in succession.

If the data request pattern generating device 100 determines that the data request sequence of the first data request pattern FM is not consistent with the data request sequence of the second data request pattern SM, the data request pattern generating device 100 proceeds to operation S250 to output a pattern comparison information PCI indicating that the first data request pattern FM is not consistent with the second data request pattern SM.

On the other hand, if the data request pattern generating device 100 determines that the data request sequence of the first data request pattern FM is consistent with the data request sequence of the second data request pattern SM, then the data request pattern generating device 100 proceeds to operation S230 to determine whether a difference between a data request time of the first data request pattern FM and a data request time of the second data request pattern SM is maintained to be equal to or less than a predetermined or otherwise desired threshold value.

If the data request pattern generating device 100 determines that a difference between the data request time of the first data request pattern FM and the data request time of the second data request pattern SM is not maintained to be equal to or less than the threshold value, then the data request pattern generating device 100 proceeds to operation S250 to output a pattern comparison information PCI indicating that the first data request pattern FM is not consistent with the second data request pattern SM.

On the other hand, if the data request pattern generating device 100 determines that a difference between the data request time of the first data request pattern FM and the data request time of the second data request pattern SM is maintained to be equal to or less than the threshold value, then the data request pattern generating device 100 proceeds to operation S240 to output a pattern comparison information PCI indicating that the first data request pattern FM is consistent with the second data request pattern SM.

FIG. 6 shows that the first data request pattern FM generated by the pattern generator 160 (i.e., a data request pattern that is currently input) is compared with the second data request patterns SM-1 through SM-5 stored in the memory device 180. For convenience of descriptions, it is assumed in FIG. 6 that a predetermined or otherwise desired threshold value for comparing the data request time of the first data request pattern FM with the data request time of the second data request pattern SM is 1 ms. As a first comparing operation CK1 is performed, the second data request patterns SM-2, SM-3, and SM-4 of which the data request sequences are different from the data request sequence of the first data request pattern FM may be excluded from comparison targets of the first data request pattern FM. Here, since the second data request patterns SM-1 and SM-5 have a duration time of 10 ms and a duration time of 8 ms, respectively, the data request times of the second data request patterns SM-1 and SM-5 may be determined to be consistent with the data request time of the first data request pattern FM. That is, a difference between a duration time of 9 ms related to the first data request pattern FM and a duration time of 10 ms related to the second data request pattern SM-1 is equal to or less than the threshold value (i.e., 1 ms), and a difference between a duration time of 9 ms related to the first data request pattern FM and a duration time of 8 ms related to the second data request pattern SM-5 is equal to or less than the threshold value (i.e., 1 ms). Subsequently, as a second comparing operation CK2 is performed, the second data request patterns SM-1 and SM-5 may have a delay time of 2 ms and a delay time of 3 ms, respectively. Thus, the data request times of the second data request patterns SM-1 and SM-5 may be determined to be consistent with the data request time of the first data request pattern FM because a difference between a delay time of 2 ms related to the first data request pattern FM and a delay time of 2 ms related to the second data request pattern SM-1 is equal to or less than the threshold value (i.e., 1 ms), and a difference between a delay time of 2 ms related to the first data request pattern FM and a delay time of 3 ms related to the second data request pattern SM-5 is equal to or less than the threshold value (i.e., 1 ms). As a third comparing operation CK3 is performed, the second data request patterns SM-1 and SM-5 may have a duration time of 8 ms and a duration time of 8 ms, respectively. Thus, the data request times of the second data request patterns SM-1 and SM-5 may be determined to be consistent with the data request time of the first data request pattern FM because a difference between a duration time of 8 ms related to the first data request pattern FM and a duration time of 8 ms related to the second data request pattern SM-1 is equal to or less than the threshold value (i.e., 1 ms), and a difference between a duration time of 8 ms related to the first data request pattern FM and a duration time of 8 ms related to the second data request pattern SM-5 is equal to or less than the threshold value (i.e., 1 ms).

However, as a fourth comparing operation CK4 is performed, the second data request patterns SM-1 and SM-5 may have a delay time of 4 ms and a delay time of 2 ms, respectively. Thus, the data request time of the second data request pattern SM-5 may be determined to be consistent with the data request time of the first data request pattern FM because a difference between a delay time of 2 ms related to the first data request pattern FM and a delay time of 2 ms related to the second data request pattern SM-5 is equal to or less than the threshold value (i.e., 1 ms). On the other hand, the data request time of the second data request pattern SM-1 may be determined to be different from the data request time of the first data request pattern FM because a difference between a delay time of 2 ms related to the first data request pattern FM and a delay time of 4 ms related to the second data request pattern SM-1 is greater than the threshold value (i.e., 1 ms). As a result, the second data request pattern SM-1 may be excluded from the comparison targets of the first data request pattern FM. Therefore, the first data request pattern FM generated by the pattern generator 160 may be determined to be consistent with the second data request pattern SM-5 stored in the memory device 180. Since a manner of comparing the first data request pattern FM with the second data request patterns SM-1 through SM-5, as illustrated in FIG. 6, is one example embodiment, the first data request pattern FM may be compared with the second data request patterns SM-1 through SM-5 in various manners, according to other example embodiments. For example, it may be determined whether the first data request pattern FM is consistent with the second data request pattern SM-5 after it is determined that the data request sequence of the first data request pattern FM is consistent with the data request sequence of the second data request pattern SM-5 by more than a predetermined or otherwise desired number of times in succession.

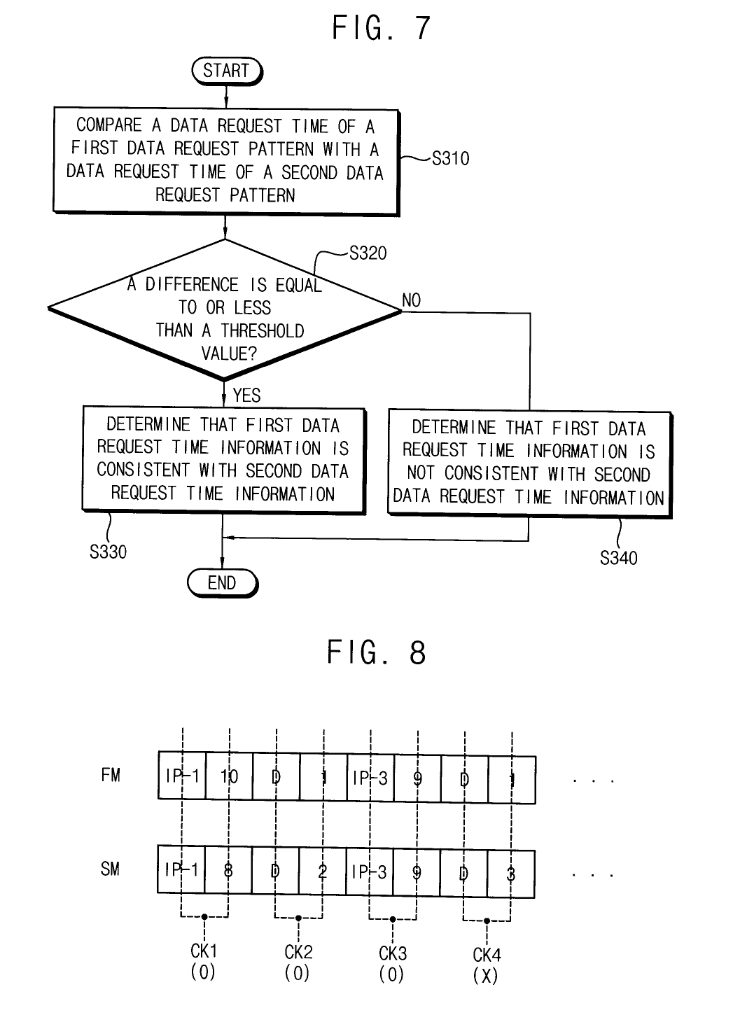

FIG. 7 is a flow chart illustrating an example in which a data request pattern generating device of FIG. 1 determines whether a data request pattern that is currently input is consistent with a data request pattern that is stored in a memory device. FIG. 8 is a diagram illustrating an example in which a data request pattern generating device of FIG. 1 determines whether a data request pattern that is currently input is consistent with a data request pattern that is stored in a memory device.

Referring to FIGS. 7 and 8, as shown in operation S310, the data request pattern generating device 100 compares a data request time (i.e., a duration time and a delay time) of a first data request pattern FM with a data request time of a second data request pattern SM. Then, as shown in operation S320, the data request pattern generating device 100 determines whether a difference between the data request time of the first data request pattern FM and the data request time of the second data request pattern SM is maintained to be equal to or less than a predetermined or otherwise desired threshold value.

If the data request pattern generating device 100 determines that a difference between the data request time of the first data request pattern FM and the data request time of the second data request pattern SM is maintained to be equal to or less than the threshold value, then the data request pattern generating device 100 proceeds to operation S330 to determine that first data request time information of the first data request pattern FM is consistent with second data request time information of the second data request pattern SM.

On the other hand, if the data request pattern generating device 100 determines that a difference between the data request time of the first data request pattern FM and the data request time of the second data request pattern SM is not maintained to be equal to or less than the threshold value, then the data request pattern generating device 100 proceeds to operation S340 to determine that the first data request time information of the first data request pattern FM is not consistent with the second data request time information of the second data request pattern SM. With regards to the example embodiment as shown in FIGS. 7-8, it is assumed that first data request sequence information of the first data request pattern FM is consistent with second data request sequence information of the second data request pattern SM.

FIG. 8 shows that the first data request pattern FM generated by the pattern generator 160 (i.e., a data request pattern that is currently input) is compared with the second data request pattern SM stored in the memory device 180. For convenience of descriptions, it is assumed in FIG. 8 that a first threshold value for comparing a duration time of the first data request pattern FM with a duration time of the second data request pattern SM is 2 ms, and a second threshold value for comparing a delay time of the first data request pattern FM with a delay time of the second data request pattern SM is 1 ms. As a first comparing operation CK1 is performed, the first data request time information may be determined to be consistent with the second data request time information because a difference (i.e., 2 ms) between the duration time (i.e., 10 ms) of the first data request pattern FM and the duration time (i.e., 8 ms) of the second data request pattern SM is equal to or less than the first threshold value (i.e., 2 ms). Subsequently, as a second comparing operation CK2 is performed, the first data request time information may be determined to be consistent with the second data request time information because a difference (i.e., 1 ms) between the delay time (i.e., 1 ms) of the first data request pattern FM and the delay time (i.e., 2 ms) of the second data request pattern SM is equal to or less than the second threshold value (i.e., 1 ms). Next, as a third comparing operation CK3 is performed, the first data request time information may be determined to be consistent with the second data request time information because a difference (i.e., 0 ms) between the duration time (i.e., 9 ms) of the first data request pattern FM and the duration time (i.e., 9 ms) of the second data request pattern SM is equal to or less than the first threshold value (i.e., 2 ms). However, as a fourth comparing operation CK4 is performed, the first data request time information may be determined to be inconsistent with the second data request time information because a difference (i.e., 2 ms) between the delay time (i.e., 1 ms) of the first data request pattern FM and the delay time (i.e., 3 ms) of the second data request pattern SM is greater than the second threshold value (i.e., 1 ms).

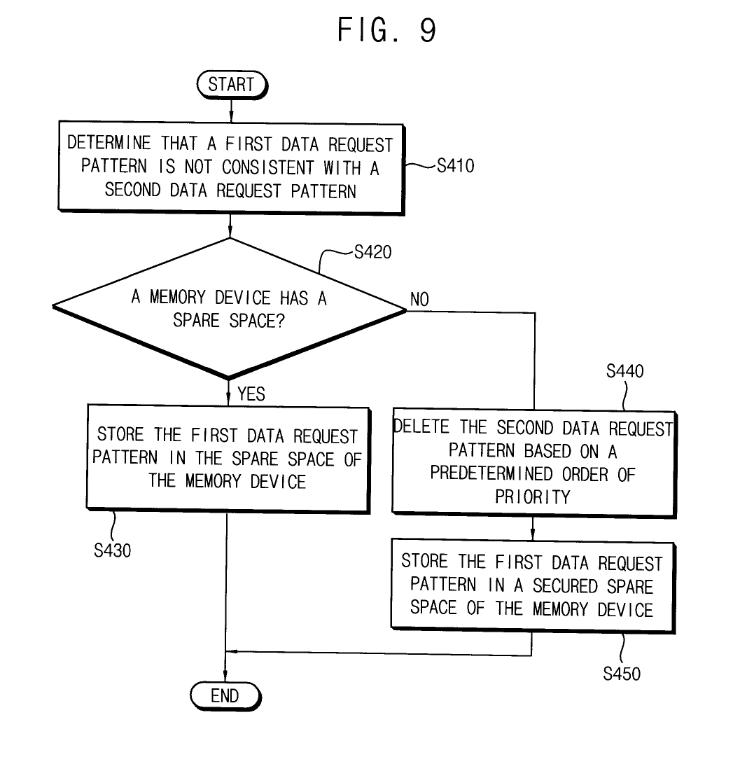

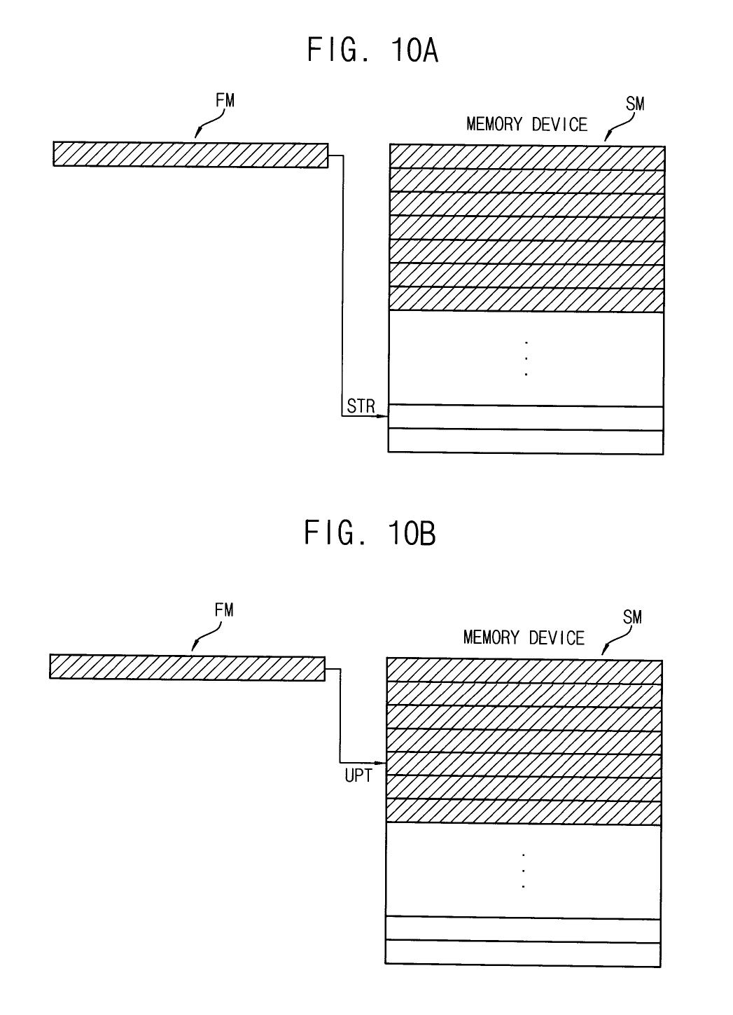

FIG. 9 is a flow chart illustrating an example in which a data request pattern generating device of FIG. 1 stores new data request pattern in a memory device. FIGS. 10A and 10B are diagrams illustrating an example in which a data request pattern generating device of FIG. 1 stores new data request pattern in a memory device.

Referring to FIG. 9, the data request pattern generating device 100 may compare the first data request pattern FM generated by the pattern generator 160 with the second data request pattern SM stored in the memory device 180. On this basis, as shown in operation S410, the data request pattern generating device 100 determines that the first data request pattern FM is not consistent with the second data request pattern SM. Thus, the data request pattern generating device 100 may store the first data request pattern FM in the memory device 180. To this end, as shown in operation S420, the data request pattern generating device 100 determines whether the memory device 180 has a spare space for storing the first data request pattern FM.

If the data request pattern generating device 100 determines that the memory device 180 has the spare space for storing the first data request pattern FM (e.g., as shown in FIG. 10A), the data request pattern generating device 100 proceeds to operation S430 to store the first data request pattern FM in the spare space of the memory device 180. As a result, the first data request pattern FM may be stored in the memory device 180 (i.e., indicated as STR).

On the other hand, if the data request pattern generating device 100 determines that the memory device 180 does not have the spare space for storing the first data request pattern FM (e.g., as shown in FIG. 10B), then the data request pattern generating device 100 proceeds to operation S440 to deletes the second data request pattern SM stored in the memory device 180 based on a predetermined or otherwise desired order of priority (e.g., according to a number of times the second data request pattern SM was generated, according to an age of the second data request pattern SM, and the like) to secure a spare space for storing the first data request pattern FM.

As shown in operation S450, the data request pattern generating device 100 stores the first data request pattern FM in the secured spare space of the memory device 180. As a result, the first data request pattern FM may be stored in the memory device 180 (i.e., indicated as UPT). In some example embodiments, when it is determined that the first data request pattern FM is consistent with the second data request pattern SM, the data request pattern generating device 100 may modify and/or update the second data request pattern SM by reflecting the first data request pattern FM.

FIG. 11 is a block diagram illustrating a data request pattern generating device according to an example embodiment.

Referring to FIG. 11, the data request pattern generating device 300 may include a sequence detector 320, a time detector 340, a pattern generator 360, and a memory device 380. Although it is illustrated in FIG. 11 that the memory device 380 is placed within the data request pattern generating device 300 (i.e., internal memory device), according to various embodiments, the memory device 180 may be placed outside the data request pattern generating device 300 (i.e., external memory device).

The sequence detector 320 may generate data request sequence information SI based on data request signals DRS output from a plurality of function blocks 210-1 through 210-n. As illustrated in FIG. 11, the function blocks 210-1 through 210-n may correspond to a plurality of internal blocks of at least one module IP-k. In this case, the sequence detector 320 may generate the data request sequence information SI related to the internal blocks of the module IP-k. The time detector 340 may generate data request time information TI based on the data request signals DRS output from the function blocks 210-1 through 210-n. Here, the data request time information TI may include a duration time of respective data request signals DRS output from the function blocks 210-1 through 210-n, a delay time between respective data request signals DRS output from the function blocks 210-1 through 210-n, etc. The pattern generator 360 may receive the data request sequence information SI from the sequence detector 320, may receive the data request time information TI from the time detector 340, and may generate a data request pattern DRP based on the data request sequence information SI and the data request time information TI. The memory device 380 may store the data request pattern DRP generated by the pattern generator 360.

As described above, the data request pattern generating device 300 may estimate an operating pattern of the function blocks 210-1 through 210-n due to a user's use habit by generating the data request pattern DRP including the data request sequence information SI and the data request time information TI based on the data request signals DRS. In such embodiments, the data request pattern generating device 300 may learn the operating pattern of the function blocks 210-1 through 210-n in a reinforcement learning manner without involvement of a central processing unit when the function blocks 210-1 through 210-n generate the data request signals DRS according to the user's use habit. In addition, since the data request pattern generating device 300 allows an electronic device to expect a generating pattern of the data request signals DRS based on the data request pattern DRP stored in the memory device 380, an electronic device having a data request pattern generating device according to the example embodiments as described herein (e.g., data request pattern generating device 300), may increase or otherwise maximize power savings by efficiently performing a power-gating operation for the function blocks 210-1 through 210-n without any involvement of the central processing unit. Meanwhile, since the data request pattern generating device 300 generates a data request pattern DRP by continuously comparing a first data request pattern generated by the pattern generator 360 with a second data request pattern stored in the memory device 380 (i.e., in the reinforcement learning manner), the data request pattern generating device 300 may reduce a probability that a generating pattern of the data request signals DRS is incorrectly expected.

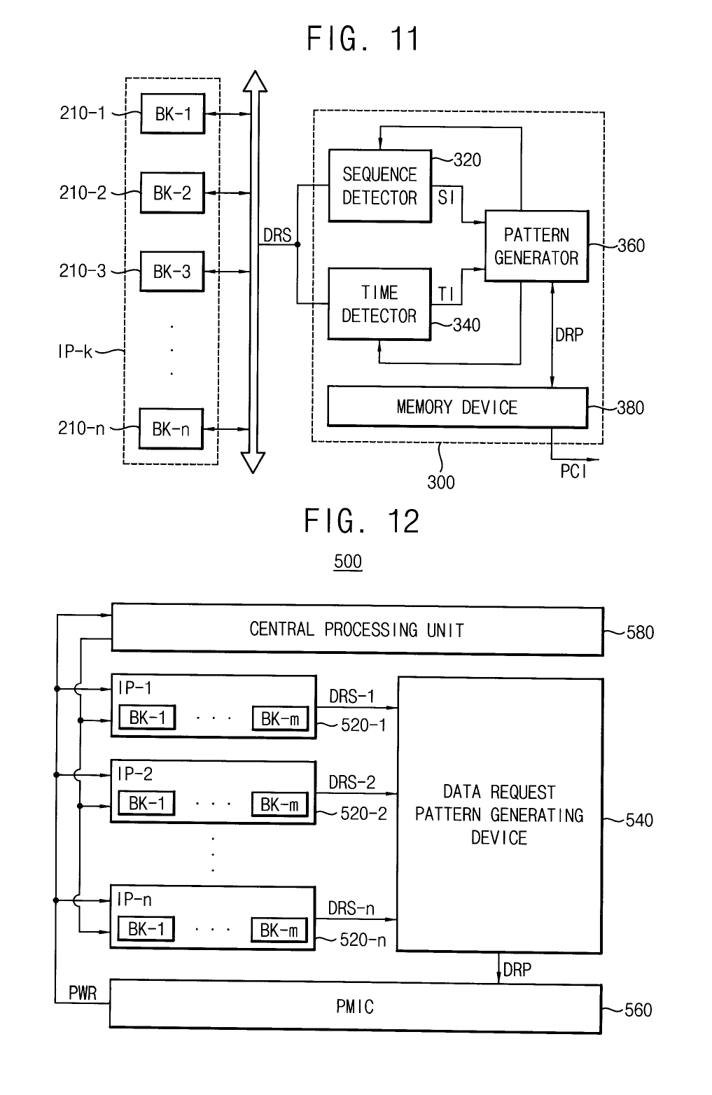

FIG. 12 is a block diagram illustrating an electronic device according to an example embodiment.

Referring to FIG. 12, the electronic device 500 may include first through (n)th function blocks 520-1 through 520-n (where n is an integer greater than or equal to 1), a data request pattern generating device 540, a power management integrated circuit 560, and a central processing unit 580. Here, the first through (n)th function blocks 520-1 through 520-n may include at least one internal block BL-1 through BK-m, respectively (where m is an integer greater than or equal to 1). Although not illustrated in FIG. 12, the electronic device 500 may further include a memory device, a storage device, a display device, an input/output (I/O) device, a communication port, and/or other like components.

The first through (n)th function blocks 520-1 through 520-n may output first through (n)th data request signals DRS-1 through DRS-n, respectively, based on internal operating modes of the first through (n)th function blocks 520-1 through 520-n. In one example embodiment, as illustrated in FIG. 12, the first through (n)th function blocks 520-1 through 520-n may correspond to a plurality of intellectual properties IP-1 through IP-n. In another example embodiment, the first through (n)th function blocks 520-1 through 520-n may correspond to a plurality of internal blocks BK-1 through BK-m included in at least one intellectual property IP-1 through IP-n. For convenience of descriptions, it is assumed in FIG. 12 that the first through (n)th function blocks 520-1 through 520-n correspond to the intellectual properties IP-1 through IP-n. Generally, the intellectual properties IP-1 through IP-n may correspond to components of the electronic device 500. Here, since intellectual properties IP-1 through IP-n require different power consumptions according to characteristics thereof, intellectual properties IP-1 through IP-n may receive power PWR from the power management integrated circuit 560 based on internal operating modes (e.g., normal mode, idle mode, and the like) thereof. In example embodiments, intellectual properties IP-1 through IP-n may be controlled by the central processing unit 580. The central processing unit 580 may perform various computing functions. The central processing unit 580 may be a micro-processor, an application processor, and/or other like processing devices. The central processing unit 580 may be coupled to other components via an address bus, a control bus, a data bus, and/or other like buses. In some example embodiments, the central processing unit 580 may be coupled to an extended bus such as a peripheral component interconnection (PCI) bus.

The data request pattern generating device 540 may generate a data request pattern DRP based on the first through (n)th data request signals DRS-1 through DRS-n, and may provide the data request pattern DRP to the power management integrated circuit 560 to perform a power-gating operation for the first through (n)th function blocks 520-1 through 520-n. The power management integrated circuit 560 may supply power PWR to the first through (n)th function blocks 520-1 through 520-n, and may perform a power-gating operation for the first through (n)th function blocks 520-1 through 520-n, respectively, based on internal operating modes of the first through (n)th function blocks 520-1 through 520-n. Based on the data request pattern DRP, the power management integrated circuit 560 may perform a power-gating operation for the first through (n)th function blocks 520-1 through 520-n by expecting a generating pattern of the first through (n)th data request signals DRS-1 through DRS-n that are currently input (i.e., by expecting an operating pattern of the first through (n)th function blocks 520-1 through 520-n due to a user's use habit). For this operation, the data request pattern generating device 540 may include a sequence detector that generates data request sequence information based on the first through (n)th data request signals DRS-1 through DRS-n, a time detector that generates data request time information based on the first through (n)th data request signals DRS-1 through DRS-n, a pattern generator that generates the data request pattern DRP based on the data request sequence information and the data request time information, and a memory device that store the data request pattern DRP. As described above, the data request pattern generating device 540 may generate pattern comparison information by determining whether a first data request pattern generated by the pattern generator (i.e., a generating pattern of the first through (n)th data request signals DRS-1 through DRS-n that are currently input) is consistent with at least one second data request pattern stored in the memory device. Here, the data request pattern generating device 540 may provide the second data request pattern for performing a power-gating operation when the first data request pattern is consistent with the second data request pattern, and may store the first data request pattern in the memory device when the first data request pattern is not consistent with the second data request pattern. Since these operations are described with reference to FIGS. 1 through 11, duplicated descriptions will not be repeated.

In brief, since the data request pattern generating device 540 allows the electronic device 500 to expect a generating pattern of the first through (n)th data request signals DRS-1 through DRS-n based on the data request pattern DRP stored in the memory device, the electronic device 500 having the data request pattern generating device 540 may increase or otherwise maximize power savings by performing a power-gating operation for the first through (n)th function blocks 520-1 through 520-n without any involvement of the central processing unit 580. Meanwhile, since the data request pattern generating device 540 generates an accurate data request pattern DRP by continuously comparing the first data request pattern generated by the pattern generator with the second data request pattern stored in the memory device (i.e., in a reinforcement learning manner), the data request pattern generating device 540 may reduce a probability that a generating pattern of the first through (n)th data request signals DRS-1 through DRS-n is wrongly expected. As a result, the electronic device 500 may accurately and rapidly perform a power-gating operation for the first through (n)th function blocks 520-1 through 520-n, respectively.

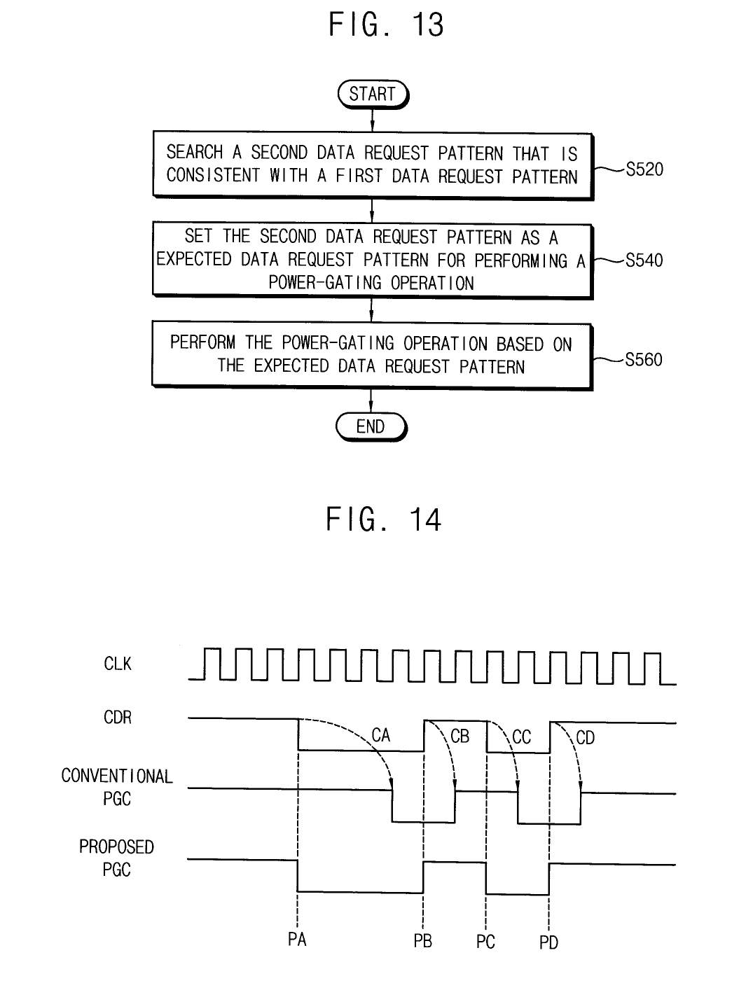

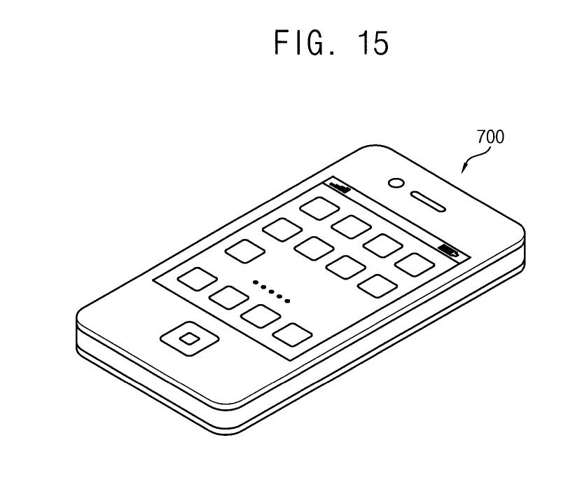

FIG. 13 is a flow chart illustrating an example in which an electronic device of FIG. 12 performs a power-gating operation based on a data request pattern. FIG. 14 is a timing diagram illustrating an example in which an electronic device of FIG. 12 performs a power-gating operation based on a data request pattern.

Referring to FIGS. 13 and 14, it is illustrated that the electronic device 500 performs a power-gating operation based on a data request pattern DRP. As shown in operation S520, the electronic device 500 searches a second data request pattern that is consistent with a first data request pattern in a memory device of the data request pattern generating device 540. The first data request pattern may correspond to a generating pattern of first through (n)th data request signals DRS-1 through DRS-n that are currently input.

As shown in operation S540, the electronic device 500 sets the second data request pattern that is consistent with the first data request pattern as an expected data request pattern for performing a power-gating operation.

As shown in operation S560, the electronic device 500 may perform the power-gating operation by expecting a generating pattern of the first through (n)th data request signals DRS-1 through DRS-n based on the expected data request pattern.

FIG. 14 shows that a power-gating operation (i.e., indicated as CONVENTIONAL PGC and PROPOSED PGC) is performed for one function block. Here, it is assumed in FIG. 14 that the electronic device 500 operates based on a clock signal CLK, and a second data request pattern that is consistent with a first data request pattern is set as an expected data request pattern. As illustrated in FIG. 14, since conventional electronic devices perform a power-gating operation (i.e., indicated as CONVENTIONAL PGC) after detecting a data request signal CDR input from one function block, the conventional electronic devices may not accurately and rapidly perform a power-gating operation (i.e., indicated as CONVENTIONAL PGC) because a specific delay (i.e., indicated as CA, CB, CC, and CD) occurs. On the other hand, since the electronic device 500 performs a power-gating operation (i.e., indicated as PROPOSED PGC) by expecting the data request signal CDR input from one function block based on the expected data request pattern, the electronic device 500 may accurately and rapidly perform a power-gating operation (i.e., indicated as PROPOSED PGC) because a specific delay (i.e., indicated as CA, CB, CC, and CD) does not occur. As described above, the electronic device 500 uses characteristics that a specific pattern of bus traffics due to a user's use habit exists. Therefore, the electronic device 500 may expect a data request pattern due to the user's use habit (i.e., an operating pattern of intellectual properties due to the user's use habit), and may efficiently perform a power-gating operation based on the expectation.

FIG. 15 is a diagram illustrating an example in which an electronic device of FIG. 12 is implemented as a smart-phone.

Referring to FIG. 15, it is illustrated that the electronic device 500 is implemented as a smart-phone 700. The smart-phone 700 may include an application processor AP, a memory device, a storage device, a plurality of function blocks, a data request pattern generating device, a power management integrated circuit, and/or other like components. As described above, the power management integrated circuit may provide power to the memory device, the storage device, the function blocks, etc, and may perform a power-gating operation for the memory device, the storage device, the function blocks, etc based on respective internal operating modes thereof. Here, the data request pattern generating device may generate a data request pattern, and may provide the data request pattern to the power management integrated circuit for the power-gating operation. As a result, based on the data request pattern, the power management integrated circuit may perform the power-gating operation by expecting a generating pattern of data request signals that are currently input (i.e., an operating pattern of the function blocks due to a user's use habit).

The application processor may control an overall operation of the smart-phone 700. However, the data request pattern generating device may generate the data request pattern without involvement of the application processor. The memory device and the storage device may store data for operations of the smart-phone 700. For example, the memory device may include a volatile semiconductor memory device such as a dynamic random access memory (DRAM) device, a static random access memory (SRAM) device, a mobile DRAM, etc, and/or a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. The storage device may include a solid state drive (SSD), a hard disk drive (HDD), a CD-ROM, etc.

In addition, the function blocks may perform various functions of the smart-phone 700. In example embodiments, the function blocks may correspond to a plurality of function modules of the smart-phone 700. For example, the smart-phone 700 may include a communication module that performs a communication function (e.g., code division multiple access (CDMA) module, long term evolution (LTE) module, radio frequency (RF) module, ultra wideband (UWB) module, wireless local area network (WLAN) module, worldwide interoperability for microwave access (WIMAX) module, etc), a camera module that performs a camera function, a display module that performs a display function, a touch panel module that performs a touch-input sensing function, etc. In some example embodiments, the smart-phone 700 may further include a global positioning system (GPS) module, a microphone (MIC) module, a speaker module, a gyroscope module, and/or other like components. However, a kind and/or number of the function modules included in the smart-phone 700 is not limited thereto.

The present inventive concepts may be applied to an electronic device that performs a power-gating operation. For example, the present inventive concepts may be applied to a computer, a laptop, a digital camera, a cellular phone, a smart-phone, a smart-pad, a personal digital assistants (PDA), a portable multimedia player (PMP), an MP3 player, a navigation system, a video camcorder, a portable game console, etc.

The foregoing is illustrative of example embodiments and is not to be construed as limiting thereof Although a few example embodiments have been described, those skilled in the art will readily appreciate that many modifications are possible in the example embodiments without materially departing from the novel teachings and advantages of the present inventive concepts. Accordingly, all such modifications are intended to be included within the scope of the present inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A data request pattern generating device comprising:
a sequence detector configured to generate data request sequence information based on a plurality of data request signals, the data request signals being output from a plurality of function blocks;
a time detector configured to generate data request time information based on the data request signals; and
a pattern generator configured to generate a data request pattern based on the data request sequence information and the data request time information.

2. The device of claim 1, further comprising:
a memory device configured to store the data request pattern.

3. The device of claim 2, wherein the plurality of function blocks correspond to a plurality of modules.

4. The device of claim 2, wherein the function blocks correspond to a plurality of internal blocks associated with at least one of the plurality of modules.

5. The device of claim 2, wherein the pattern generator is configured to generate pattern comparison information by determining whether a first data request pattern is consistent with at least one second data request pattern,
the first data request pattern corresponds to the data request signals that are currently input, and
the at least one second data request pattern is stored in the memory device.

6. The device of claim 5, wherein
the first data request pattern includes data request sequence information that indicates a first data request sequence, and the second data request pattern includes second data request sequence information that indicates a second data request sequence, and
the data request pattern generating device is configured to determine that the first data request sequence information is consistent with the second data request sequence information when the first data request sequence is compared with the second data request sequence multiple times in succession, and based on the comparison, the first data request sequence substantially matches the second data request sequence more than a desired number of times.

7. The device of claim 6, wherein the first data request pattern includes first data request time information indicating a first data request time, and the second data request pattern includes second data request time information indicating a second data request time, and
the data request pattern generating device is configured to determine that the first data request time information is consistent with the second data request time information when a difference between the first data request time and the second data request time is maintained to be equal to or less than a threshold value.

8. The device of claim 7, further comprising:
a power management integrated circuit (PMIC) is configured to use the second data request pattern for performing a power-gating operation when the first data request pattern is consistent with the second data request pattern.

9. The device of claim 7, wherein the pattern generator is configured to store the first data request pattern in the memory device when the first data request pattern is inconsistent with the second data request pattern.

10. An electronic device comprising:
first through (n)th function blocks configured to output first through (n)th data request signals, where n is an integer equal to or greater than 1, each of the first through (n)th function blocks having an internal operation mode, and the request signals being based on the internal operating mode of each of the first through (n)th function blocks;
a power management integrated circuit configured to
supply power to the first through (n)th function blocks, and
perform a power-gating operation for the first through (n)th function blocks based on the internal operating mode of each of the first through (n)th function blocks; and
a data request pattern generating device configured to
generate a data request pattern based on the first through (n)th data request signals, and
provide the data request pattern to the power management integrated circuit for the power-gating operation.

11. The device of claim 10, wherein the data request pattern generating device includes:
a sequence detector configured to generate data request sequence information based on the first through (n)th data request signals;
a time detector configured to generate data request time information based on the first through (n)th data request signals;
a pattern generator configured to generate the data request pattern based on the data request sequence information and the data request time information; and
a memory device configured to store the data request pattern.

12. The device of claim 11, further comprising:
a plurality of intellectual properties, each of the plurality of intellectual properties including a plurality of internal blocks; and
the first through (n)th function blocks correspond to at least one of the plurality of intellectual properties and at least one of the plurality of internal blocks.

13. The device of claim 12, wherein the data request pattern generating device is configured to
generate a first data request pattern corresponding to a currently input data request pattern, the first data request pattern being based on a data request pattern of the first through (n)th data request signals, and
generate pattern comparison information by determining whether the first data request pattern is consistent with at least one second data request pattern, the second data request pattern being stored in the memory device,
the determination being based on multiple comparisons of the first data request pattern and the second data request pattern, and based on the comparisons, the first data request pattern is consistent with the second data request pattern if the first data request pattern substantially matches the second data request pattern more than a desired number of times.

14. The device of claim 13, wherein the data request pattern generating device is configured to use the second data request pattern to perform the power-gating operation when the first data request pattern is consistent with the second data request pattern.

15. The device of claim 13, wherein the data request pattern generating device is configured to store the first data request pattern in the memory device when the first data request pattern is inconsistent with the second data request pattern.

16. A data request pattern generating device configured to
learn an operating pattern without involvement of a central processing unit; and
perform a power-gating operation without involvement of a central processing unit, the power-gating operation being performed according to the learned operating pattern.

17. The device of claim 16, wherein the operating pattern is based on a use pattern of a plurality of function blocks.

18. The device of claim 17, further configured to
generate a data request pattern based on the use pattern, the data request pattern including data request sequence information and data request time information.

19. The device of claim 18, further configured to
generate pattern comparison information by determining whether a first data request pattern is consistent with at least one second data request pattern,
the first data request pattern is based on a currently input data request pattern, and
the second data request pattern being stored in a memory device, the second data request pattern being based on a previously input data request pattern.

20. The device of claim 19, further configured to
determine whether the first data request pattern is consistent with the second data request pattern,
store the first data request pattern in the memory device if the first data request pattern is determined not to be consistent with the second data request pattern, and
use the second data request pattern for performing the power-gating operation if the first data request pattern is determined to be consistent with the second data request pattern.
